(19) United States
(12) Patent Application Publication
(10) Pub. No.: US 2026/0072814 A1
(43) Pub. Date: Mar. 12, 2026

(54) AUTOMATIC TEST DATA GENERATION FOR APPLICATION TESTING

(71) Applicant: Capital One Services, LLC, McLean, VA (US)

(72) Inventors: Matthew Louis NOWAK, Midlothian, VA (US); Cory WILLIAMS, Woodbridge, VA (US); Michael Anthony YOUNG, JR., Henrico, VA (US); Lindsay HELBING, Manakin Sabot, VA (US); Alan Christopher WEAVER, Glen Allen, VA (US); Christopher MCDANIEL, Glen Allen, VA (US); Luis DE LUCA, Cumming, GA (US); Mohamed SECK, Aubrey, TX (US)

(21) Appl. No.: 18/828,670

(22) Filed: Sep. 9, 2024

(51) Int. Cl. G06F 11/36

(52) U.S. Cl. CPC G06F 11/3688; G06F 11/3684

(57) ABSTRACT

In some implementations, a testing system may receive a request for generation, based on a first dataset, of a second dataset, wherein the first dataset is associated with execution of a set of tests on an application, wherein the first dataset includes one or more data elements that satisfy one or more criteria for classification as private information. The testing system may process, using a machine learning model, the first dataset to identify one or more characteristics of the first dataset. The testing system may generate, using the machine learning model, the second dataset based on the first dataset, wherein the second dataset includes artificially generated data elements. The testing system may transmit an output identifying the second dataset.

### BACKGROUND

A computing device may include a software application using a data set. However, some data may be subject to restrictions on use by computing systems. For example, medical data, location data, personal information, financial data, intellectual property, or other types of data may have usage restrictions. Examples of legal compliance restrictions that data may be subject to include General Data Protection Regulation (GDPR) compliance, Health Insurance Portability and Accountability Act (HIPAA) compliance, California Consumer Privacy Act (CCPA) compliance, or Sarbanes-Oxley Act compliance, among other examples. Further, some entities may subject data to entity-specific restrictions. For example, a financial services entity may establish privacy standards for usage of consumer financial data. Similarly, a research entity may establish privacy standards for usage of intellectual property, such as trade secret data or other intellectual property.

### SUMMARY

In some implementations, a system for application testing includes one or more memories, and one or more processors, communicatively coupled to the one or more memories, configured to: receive a request to execute a set of tests on an application using a first dataset, wherein the first dataset includes one or more data elements that satisfy one or more criteria for classification as private information; process, using a machine learning model, the first dataset to identify one or more characteristics of the first dataset; generate, using the machine learning model, a second dataset based on the first dataset, wherein the second dataset includes artificially generated data elements, wherein the artificially generated data elements are associated with the one or more characteristics identified for the first dataset, and wherein the artificially generated data elements do not satisfy the one or more criteria for classification as private information; execute the set of tests on the application using the second dataset; and transmit an output identifying a result of executing the set of tests.

In some implementations, a non-transitory computer-readable medium storing a set of instructions includes one or more instructions that, when executed by one or more processors of a device, cause the device to: receive a request to execute a set of tests on an application using a first test environment, wherein the first test environment includes one or more data elements that satisfy one or more criteria for classification as having private information; process, using a machine learning model, the first test environment to identify one or more characteristics of the first test environment; generate, using the machine learning model, a second test environment based on the first test environment, wherein the second test environment includes artificially generated test elements, wherein the artificially generated test elements are associated with the one or more characteristics identified for the first test environment, and wherein the artificially generated test elements do not satisfy the one or more criteria for classification as having private information; execute the set of tests on the application using the second test environment; and transmit an output identifying a result of executing the set of tests.

In some implementations, a method for application testing includes receiving, by a testing system, a request for generation, based on a first dataset, of a second dataset, wherein the first dataset is associated with execution of a set of tests on an application, wherein the first dataset includes one or more data elements that satisfy one or more criteria for classification as private information; processing, using a machine learning model, the first dataset to identify one or more characteristics of the first dataset; generating, using the machine learning model, the second dataset based on the first dataset, wherein the second test environment includes artificially generated test elements, wherein the artificially generated data elements are associated with the one or more characteristics identified for the first dataset, and wherein the artificially generated data elements do not satisfy the one or more criteria for classification as private information; and transmitting, by the testing system, an output identifying the second dataset.

### BRIEF DESCRIPTION OF THE DRAWINGS

FIGS. 1A-1D are diagrams of an example associated with automatic test data generation for application testing, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with automatic test data generation for application testing, in accordance with some embodiments of the present disclosure.

FIG. 4 is a flowchart of an example process associated with automatic test data generation for application testing, in accordance with some embodiments of the present disclosure.

### DETAILED DESCRIPTION

The following detailed description of example implementations refers to the accompanying drawings. The same reference numbers in different drawings may identify the same or similar elements.

Some implementations described herein enable automatic test data generation for application testing. As a result, a testing system may improve information privacy and security while providing for testing of software applications. Further, by generating artificial test data that shares a set of characteristics with a test data set, the testing system may reduce a likelihood of a set of tests failing to accurately assess performance of a software application.

Entities may use software components to manipulate data sets and generate outputs associated with the data sets. For example, a chemical processing system may use hundreds, thousands, or millions of sensor measurements as inputs to a software component that may predict one or more control parameters for controlling production of a manufacturing output.

Similarly, an entity may use a software component to analyze health data regarding a set of patients to derive information regarding whether a particular intervention (e.g., medicine or treatment) is effective. In a fraud detection context, a transaction processing software component may use data regarding previous transactions to determine whether a particular transaction is fraudulent and to determine whether to process or reject the particular transaction.

However, some data sets involve private or otherwise protected data. For example, some data sets are protected under personal healthcare data restrictions, data privacy restrictions, financial privacy restrictions, intellectual property restrictions, or other restrictions for preventing unwanted disclosure of personal information. In such cases, testing a software component, such as an application or an artificial intelligence model within an application (e.g., an artificial intelligence model that is trained on or that uses a data set), that includes protected data may risk inadvertent disclosure of the protected data. Accordingly, it may be desirable to enable testing of software components without including protected data in test data sets. However, omitting protected data from the test data sets may result in non-representative data sets, which may reduce an accuracy of testing using the data sets. In other words, when a data set, which is used to test a software component, is not representative of actual data that the software component will use upon deployment, the testing may fail to reveal any errors in the software component, which may result in poor performance of the software component upon deployment. Similarly, other data sets may be entirely protected data, thereby eliminating a possibility of using such data sets without exposing the protected data. Furthermore, some data sets with protected data may have limited amounts of data entries therein, as a result of the protection of the data set, which may prevent usage of the data sets for test cases that rely on large data sets.

Some implementations described herein enable automatic test data generation for application testing. For example, a testing system may generate test data using a set of characteristics of an original data set, as described in more detail herein. In this case, the automatically generated test data set may be used for testing of an application (or an artificial intelligence model thereof), without exposing the underlying, original, protected data set. In this way, the testing system improves information security by reducing a likelihood of a data leak. Additionally, or alternatively, by generating the test data to share characteristics with the original, protected data set, the testing system improves data testing relative to using a static, non-representative test data set for testing.

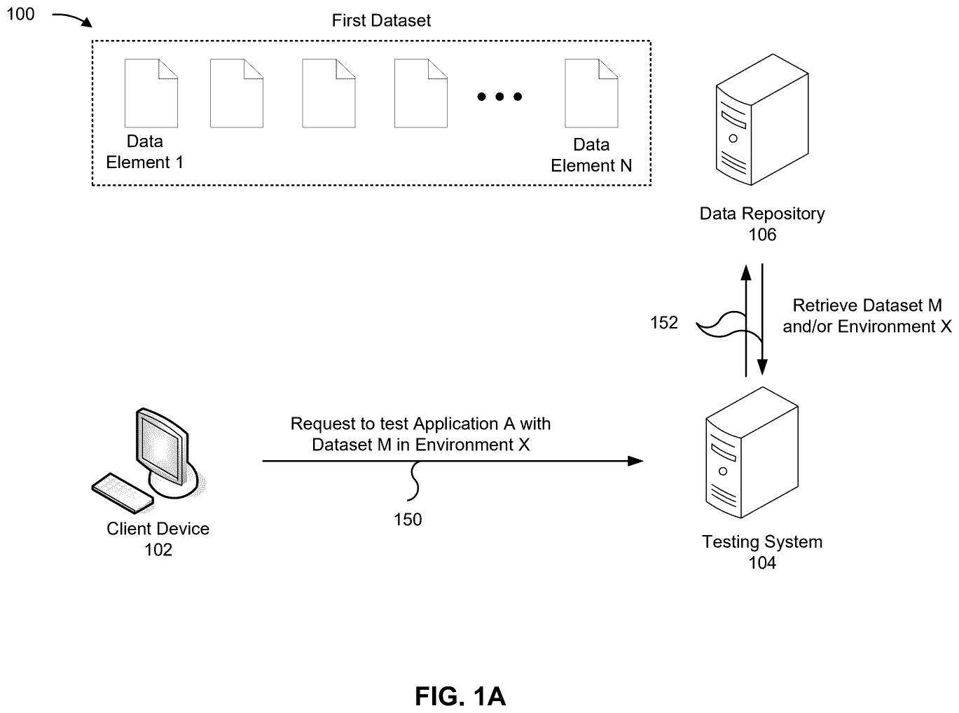

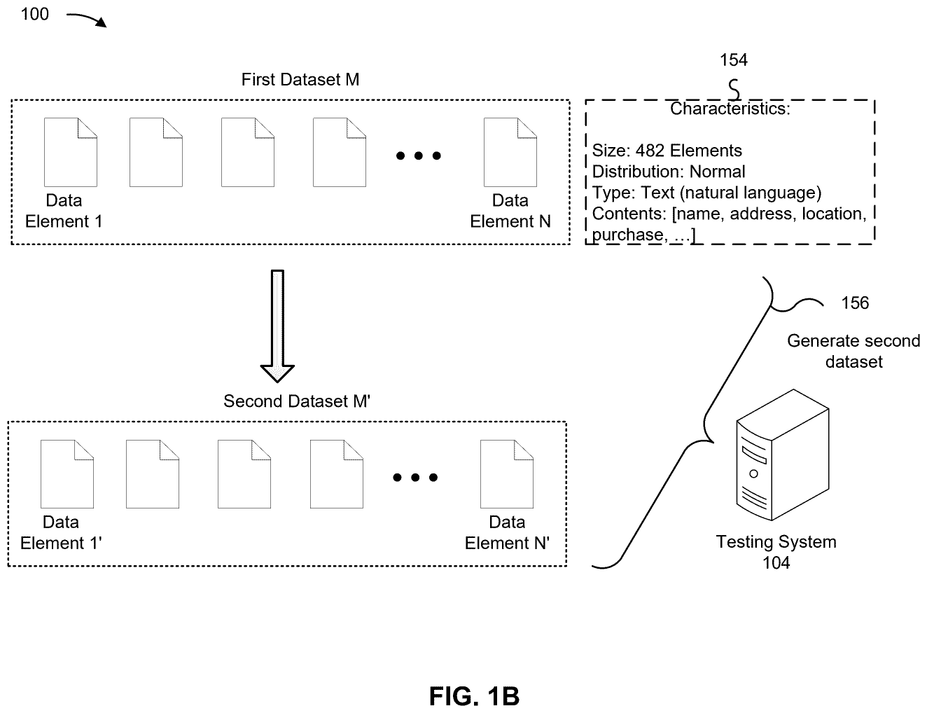

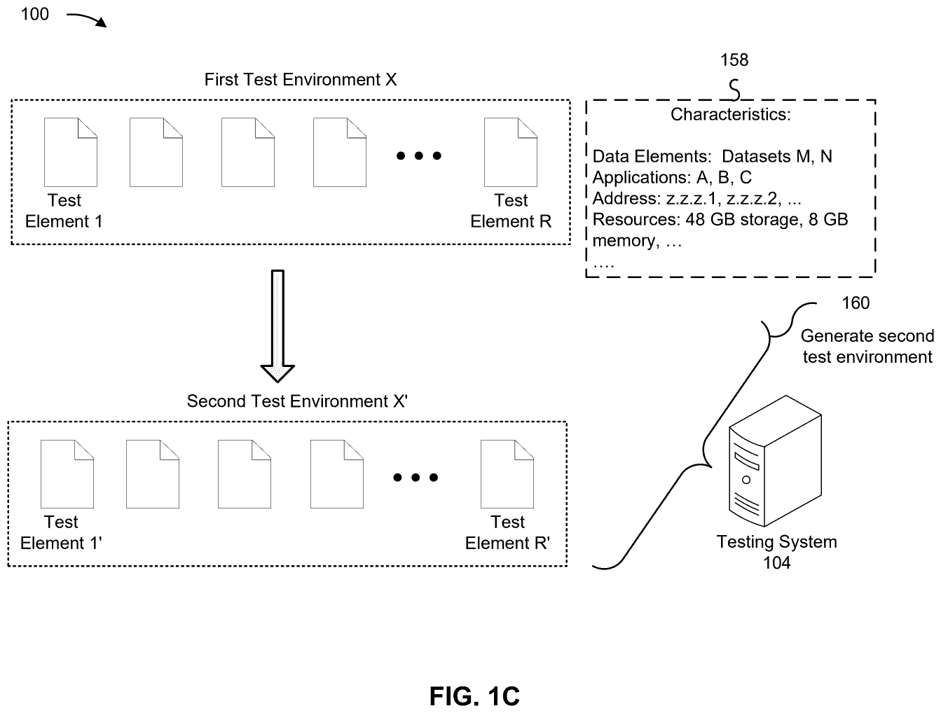

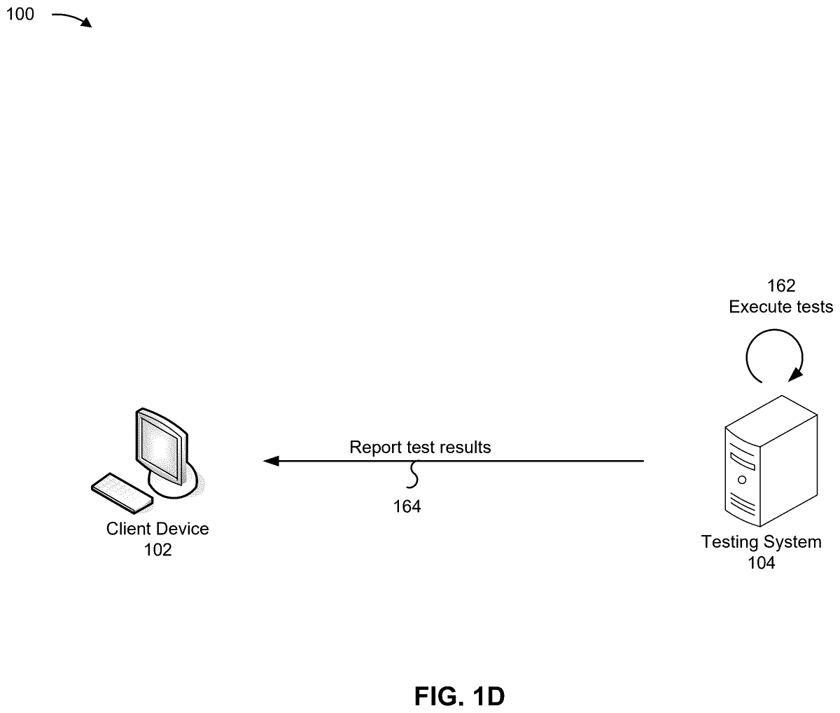

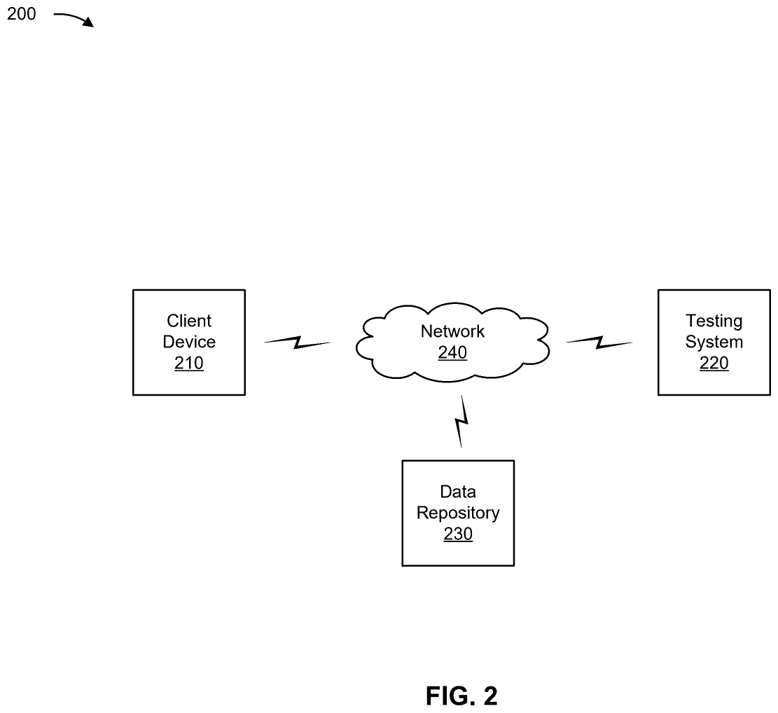

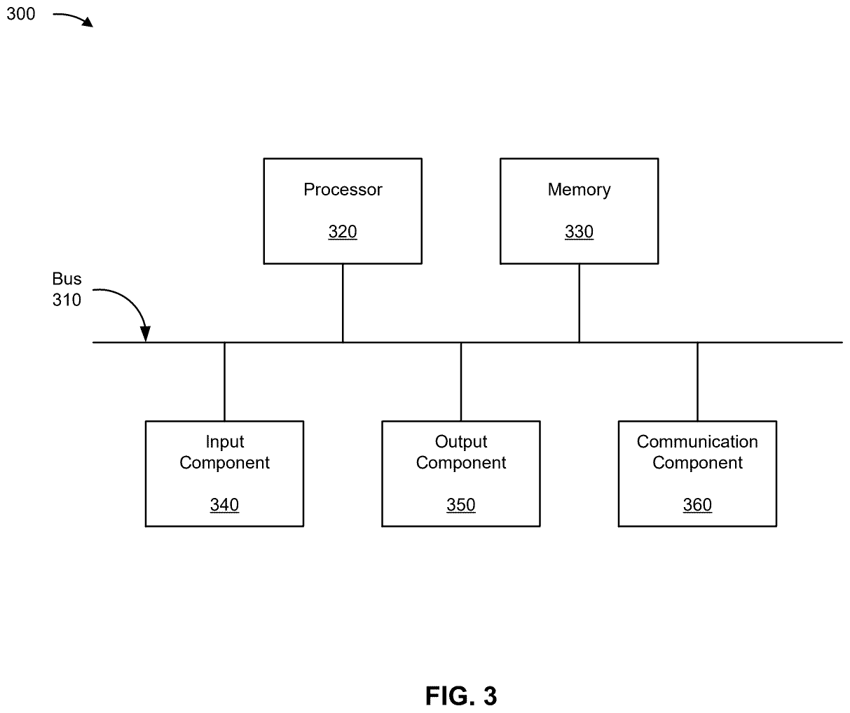

FIGS. 1A-1D are diagrams of an example 100 associated with automatic test data generation for application testing. As shown in FIGS. 1A-1D, example 100 includes a client device 102, a testing system 104, and a data repository 106. These devices are described in more detail in connection with FIGS. 2 and 3.

As further shown in FIG. 1A, and by reference number 150, the testing system 104 may receive a request to test an application. For example, the testing system 104 may receive a request to test a first application A with a first dataset M in a first testing environment X. In some implementations, the testing system 104 may receive information identifying a set of tests to execute on an application. For example, the testing system 104 may receive a request to test one or more functionalities of an application and may identify a dataset that includes data for performing the tests on the one or more functionalities. In some implementations, the testing system 104 may determine that the dataset includes private information. For example, the testing system 104 may determine that one or more data elements within the dataset satisfy one or more criteria for classifying the dataset (or the one or more data elements thereof) as private information. In this case, the one or more criteria may relate to a content of the data (e.g., whether personal identification information is included in the data), a source of the data (e.g., whether the data is received from a private source), or a level of anonymization of the data (e.g., the data may be anonymized with a particular technique that does not satisfy a compliance requirement, confidentiality requirement, or restricted access requirement), among other examples. In some implementations, the private information may relate to confidential information (e.g., trade secret information), personal identification information (e.g., user data), restricted access information (e.g., data that is available to some system users but not others), or compliance-subjected information (e.g., health data or economic data).

In some implementations, the testing system 104 may identify the dataset and/or the testing environment based on the application. For example, the testing system 104 may use an artificial intelligence (AI) model to parse a codebase of the application and identify one or more datasets that the application uses. Additionally, or alternatively, the testing system 104 may identify one or more other applications that interact with the dataset or the application (e.g., one or more other applications that call an application programming interface (API) of the application being tested or that have an API that is called by the application being tested). In this case, the testing system 104 may identify a testing environment that provides access to the one or more datasets and/or the one or more applications. For example, the testing system 104 may select a testing environment (or a testing lane thereof), from a set of testing environments, that includes instantiated instances of the application being tested, one or more other applications interacting with the application being tested, one or more datasets, or one or more computing resources, among other examples.

As further shown in FIG. 1A, and by reference number 152, the testing system 104 may retrieve information associated with a dataset and/or a testing environment for testing the application. For example, the testing system 104 may communicate with the data repository 106 to request and receive the first dataset M and/or receive access to or configuration information for instantiating the first testing environment X. In some implementations, the testing system 104 may obtain information identifying one or more data elements that satisfy one or more criteria for classification as private information. For example, the testing system 104 may receive metadata for the dataset that indicates which data elements of the dataset include private information. In this way, the testing system 104 may generate replacement data at a data element level, thereby reducing processing resource utilization relative to generation of replacement data at a dataset level.

As shown in FIG. 1B, and by reference number 154, the testing system 104 may identify a set of characteristics of a dataset. For example, the testing system 104 may analyze the first dataset M, which includes a group of data elements 1 through N, and may identify a set of characteristics of the first dataset M. In some implementations, the testing system 104 may identify one or more statistical or numerical characteristics of the dataset. For example, the testing system 104 may determine a statistical shape, which may include a quantity of data elements in the dataset or a statistical distribution of the data elements in the dataset. Additionally, or alternatively, the testing system 104 may determine a type of data in the dataset, such as determining that a first subset of the dataset includes natural language data (e.g., text), that a second subset of the dataset includes numerical data, or that a third subset of the dataset includes structured data (e.g., metadata, program code, alphanumeric data, or another type of data), among other examples. In some implementations, the testing system 104 may determine a set of fields in the dataset. For example, the testing system 104 may determine that the dataset includes a first subset of fields with a set of names, a second subset of fields with a set of addresses, or a third subset of fields with a set of transactions, among other examples.

As further shown in FIG. 1B, and by reference number 156, the testing system 104 may generate a second dataset. For example, based on the set of characteristics of the first dataset M, the testing system 104 may generate a second dataset M′, which shares the set of characteristics with the first dataset and which includes a set data elements 1 through N′. In some implementations, the testing system 104 may generate the second dataset using a machine learning (ML) or AI model. For example, the testing system 104 may provide the first dataset and/or the set of characteristics of the first dataset as input to an ML model to generate a new, second dataset. In this case, the second dataset may share the set of characteristics with the first dataset (e.g., to a threshold similarity level, such as having numeric characteristics that are within a threshold amount of each other). As an example, the first dataset and the second dataset may have similar data volumes (e.g., data elements) to within a threshold percentage. Additionally, or alternatively, the first dataset and the second dataset may include values with the same mean. In other words, a numeric field of the second dataset may have the same statistical distribution of values as a corresponding numeric field in the first dataset. Additionally, or alternatively, the numeric field of the second dataset may have a statistical distribution that is within a threshold amount of a statistical distribution of the corresponding numeric field in the first dataset (e.g., the numeric field and corresponding numeric field may have average values within a threshold amount, or standard deviations within a threshold amount).

In some implementations, the testing system 104 may use one or more artificial data generation techniques to generate anonymized datasets, such as by applying data masking, pseudonymization, generalization, data swapping, noise addition, differential privacy, suppression, encryption, or aggregation, among other examples. In some implementations, the testing system 104 may execute an initial subset of tests to determine whether the second dataset is usable to test the application. In this case, when the second dataset is not usable to test the application, the testing system 104 may provide a feedback indicator to, for example, an ML model to cause the ML model to be re-trained and re-used to provide a new, third dataset. In some implementations, the testing system 104 may transmit an alert when executing the initial subset of tests. For example, the testing system 104 may transmit an alert indicating a failure associated with generation of at least a portion of the second dataset. Based on transmitting the alert, the testing system 104 may receive a command to generate a new portion of the second dataset or receive a command re-train an ML model or AI model, among other examples.

In some implementations, the testing system 104 may train an AI model on the first dataset and use the AI model to generate the second dataset. For example, the testing system 104 may feed the first dataset (e.g., a natural language dataset) into a model training system to train a text generation type of AI model (e.g., a large-language model (LLM)) and may use the text generation type of AI model to generate a new, second dataset that includes artificial text. Additionally, or alternatively, the testing system 104 may generate a dataset using configured text snippets. For example, the testing system 104 may be configured with a set of text snippets, such as “Lorem Ipsum” text and may insert the text snippets as artificial data in a dataset. In some implementations, the testing system 104 may monitor the first dataset and update the second dataset dynamically. For example, when the testing system 104 identifies an update to the first dataset or detects a change to the first dataset, the testing system 104 may use the trained AI model (or a re-trained AI model) to re-process the first dataset, determine an updated characteristic of the first dataset, and update the second dataset to match the updated characteristic.

In some implementations, the testing system 104 may analyze the second dataset to validate that the second dataset corresponds to the first dataset. For example, the testing system 104 may determine whether the first dataset and the second dataset are associated with respective metrics that match or are within a configured amount of each other. In some implementations, the testing system 104 may organize the second dataset in a particular data structure. For example, the testing system 104 may generate a database, a data lake, or another type of data structure to store the second dataset (e.g., with the data repository 106). In this way, the testing system 104 may facilitate re-use of the second dataset for subsequent testing that is requested on the first dataset from which the second dataset is generated.

In some implementations, the testing system 104 may generate data for the second dataset in real-time. For example, the testing system 104 may read in data from a test and generate artificial data for the test as each test is being executed. Additionally, or alternatively, the testing system 104 may generate data for the second dataset in batches. For example, the testing system 104 may process an entirety of the first dataset or a configured subset of the first dataset and generate the entirety of the second dataset or a corresponding subset of the second dataset as a batch process.

As shown in FIG. 1C, and by reference number 158, the testing system 104 may identify a set of characteristics of a testing environment. For example, the testing system 104 may analyze the first testing environment X, which includes a set of test elements 1 through R, and may identify a set of characteristics of the first testing environment X. As shown by reference number 160, the testing system 104 may generate a testing environment. For example, based on the set of characteristics of the first testing environment X, the testing system 104 may generate a second testing environment X′, which shares the set of characteristics with the first testing environment and which includes a set of test elements 1 through R′. For example, the testing system 104 may generate one or more datasets or applications for testing an application under test. The characteristics of a testing environment may include a resource allocation of a test environment (e.g., computing or physical resources allocated to the testing environment), a set of applications available in the first test environment, or a set of data structures available in the first test environment, among other examples.

Additionally, or alternatively, the testing system 104 may assign a group of network addresses or resource addresses, computing resources, or physical resources for testing an application. In some implementations, the testing system 104 may apply one or more anonymization techniques, such as by changing or updating a set of network addresses or resource addresses, or providing an interface for a set of applications to avoid a security risk associated with exposing the set of network addresses or the set of applications during testing.

For example, the testing system 104 may generate a mapping table identifying a mapping of a set of artificial network addresses of a generated testing environment to a set of actual network addresses of the actual testing environment. Additionally, or alternatively, the testing system 104 may generate a mapping table of a set of application programming interface (API) commands that can be received in the generated testing environment to a set of API commands that are to be called on one or more actual applications.

In some implementations, the testing system 104 may instantiate and/or configure one or more testing lanes. For example, the testing system 104 may allocate a set of resources for an instance or copy of a testing environment using a set of configuration parameters to generate the instance or copy on-demand. In this case, by generating an instance or copy of the testing environment on demand, the testing system 104 may preserve information privacy by, for example, preventing disclosure of private information in connection with using the testing environment, such as preventing disclosure of a set of network addresses (e.g., which may be replaced with anonymized network addresses), a set of applications (e.g., which may be replaced with anonymized applications), a set of datasets, or other components of the testing environment.

As shown in FIG. 1D, and by reference number 162, the testing system 104 may execute a set of tests on the application A. For example, the testing system 104 may use the dataset M′ to test the application A in the testing environment X′. In this case, the testing system 104 may determine a result of executing the set of tests, such as a set of test results, a set of errors, a system performance, or another type of test result. As shown by reference number 164, the testing system 104 may output information associated with executing the set of tests. For example, the testing system 104 may transmit a report identifying a set of results of executing the set of tests. Additionally, or alternatively, the testing system 104 may automatically deploy an application. For example, based on an application passing a threshold percentage of the set of tests, the testing system 104 may automatically deploy the application from a test environment to a production environment. Additionally, or alternatively, the testing system 104 may automatically resolve an error. For example, the testing system 104 may detect an error in a functionality of the application based on the test results and may use a code generation model (e.g., an AI model, an ML model, or an LLM) to generate code to resolve the error or to add a new functionality to correct the error.

As indicated above, FIGS. 1A-1D are provided as an example. Other examples may differ from what is described with regard to FIGS. 1A-1D.

FIG. 2 is a diagram of an example environment 200 in which systems and/or methods described herein may be implemented. As shown in FIG. 2, environment 200 may include a client device 210, a testing system 220, a data repository 230, and a network 240. Devices of environment 200 may interconnect via wired connections, wireless connections, or a combination of wired and wireless connections.

The client device 210 may include one or more devices capable of receiving, generating, storing, processing, and/or providing information associated with automatic test data generation for application testing, as described elsewhere herein. The client device 210 may include a communication device and/or a computing device. For example, the client device 210 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The testing system 220 may include one or more devices capable of receiving, generating, storing, processing, providing, and/or routing information associated with testing an application, as described elsewhere herein. The testing system 220 may include a communication device and/or a computing device. For example, the testing system 220 may include a server, such as an application server, a client server, a web server, a database server, a host server, a proxy server, a virtual server (e.g., executing on computing hardware), or a server in a cloud computing system. In some implementations, the testing system 220 may include computing hardware used in a cloud computing environment.

The data repository 230 may include one or more devices capable of receiving, generating, storing, processing, and/or providing information associated with data generation for application testing, as described elsewhere herein. The data repository 230 may include a communication device and/or a computing device. For example, the data repository 230 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the data repository 230 may store a set of data elements that can be used to test an application, as described elsewhere herein.

The network 240 may include one or more wired and/or wireless networks. For example, the network 240 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 240 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with automatic test data generation for application testing. The device 300 may correspond to client device 210, testing system 220, and/or data repository 230. In some implementations, client device 210, testing system 220, and/or data repository 230 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

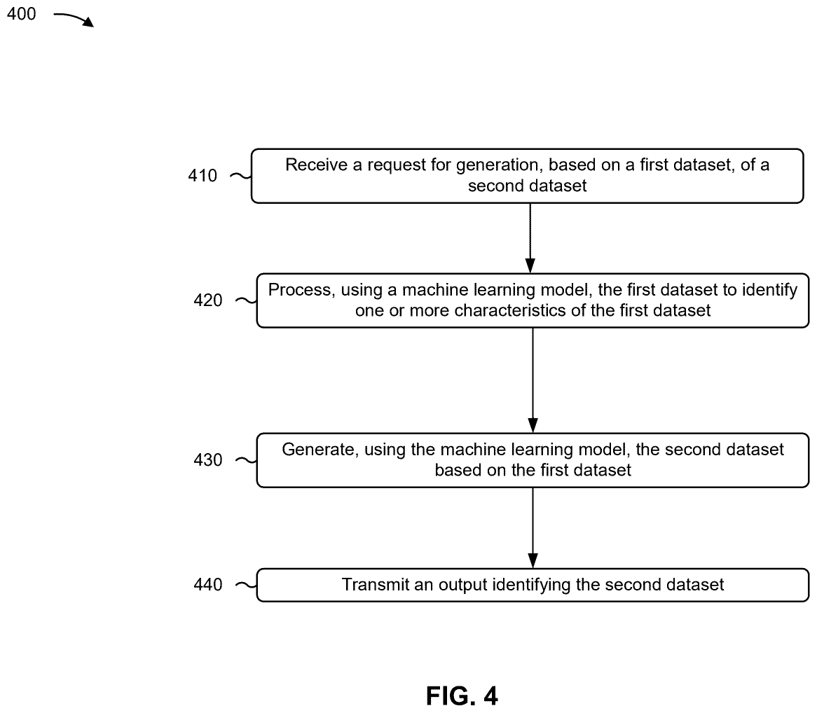

FIG. 4 is a flowchart of an example process 400 associated with automatic test data generation for application testing. In some implementations, one or more process blocks of FIG. 4 may be performed by the testing system 220. In some implementations, one or more process blocks of FIG. 4 may be performed by another device or a group of devices separate from or including the testing system 220, such as the client device 210 and/or the data repository 230. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include receiving a request for generation, based on a first dataset, of a second dataset (block 410). For example, the testing system 220 (e.g., using processor 320, memory 330, input component 340, and/or communication component 360) may receive a request for generation, based on a first dataset, of a second dataset, as described above in connection with reference number 150 of FIG. 1A. As an example, the testing system 220 may receive a request to test an application using a particular dataset and/or within a particular testing environment. In some implementations, the first dataset is associated with execution of a set of tests on an application. In some aspects, the first dataset includes one or more data elements that satisfy one or more criteria for classification as private information.

As further shown in FIG. 4, process 400 may include processing, using a machine learning model, the first dataset to identify one or more characteristics of the first dataset (block 420). For example, the testing system 220 (e.g., using processor 320 and/or memory 330) may process, using a machine learning model, the first dataset to identify one or more characteristics of the first dataset, as described above in connection with reference number 154 of FIG. 1B. As an example, the testing system 220 may determine that the first dataset is associated with a particular size, statistical distribution, type of data, or set of fields, among other examples.

Additionally, or alternatively, the testing system 220 may identify a set of characteristics of a data environment, such as a set of data elements, a set of applications, a set of network addresses, or a set of resources, among other examples, as described above in connection with reference number 158 of FIG. 1C.

As further shown in FIG. 4, process 400 may include generating, using the machine learning model, the second dataset based on the first dataset (block 430). For example, the testing system 220 (e.g., using processor 320 and/or memory 330) may generate, using the machine learning model, the second dataset based on the first dataset, wherein the second test environment includes artificially generated test elements, wherein the artificially generated data elements are associated with the one or more characteristics identified for the first dataset, and wherein the artificially generated data elements do not satisfy the one or more criteria for classification as private information, as described above in connection with reference number 156 of FIG. 1B. As an example, the testing system 220 may generate a second dataset that has the same or similar characteristics as the first dataset, such as the same size, the same statistical distribution, the same type of data, or the same set of fields, among other examples. In some implementations, the second test environment includes artificially generated data elements. In some implementations, the artificially generated data elements are associated with the one or more characteristics identified for the first dataset. In some implementations, the artificially generated data elements do not satisfy the one or more criteria for classification as private information. Additionally, or alternatively, the testing system 220 may generate a second test environment that has the same or similar characteristics as the first test environment, as described above in connection with reference number 160 of FIG. 1C.

As further shown in FIG. 4, process 400 may include transmitting an output identifying the second dataset (block 440). For example, the testing system 220 (e.g., using processor 320, memory 330, and/or communication component 360) may transmit an output identifying the second dataset, as described above in connection with reference number 164 of FIG. 1D. As an example, the testing system 220 may execute a set of tests using the second dataset and/or a second environment and may transmit output identifying a result of executing the set of tests.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1D. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for application testing, the system comprising:
one or more memories; and
one or more processors, communicatively coupled to the one or more memories, configured to:
receive a request to execute a set of tests on an application using a first dataset,
wherein the first dataset includes one or more data elements that satisfy one or more criteria for classification as private information;
process, using a machine learning model, the first dataset to identify one or more characteristics of the first dataset;
generate, using the machine learning model, a second dataset based on the first dataset,
wherein the second dataset includes artificially generated data elements,
wherein the artificially generated data elements are associated with the one or more characteristics identified for the first dataset, and
wherein the artificially generated data elements do not satisfy the one or more criteria for classification as private information;
execute the set of tests on the application using the second dataset; and
transmit an output identifying a result of executing the set of tests.

2. The system of claim 1, wherein the one or more processors, to process the first dataset to identify the one or more characteristics of the first dataset, are configured to:
identify a statistical shape of the first dataset; and
wherein the one or more processors, to generate the second dataset, are configured to:
generate the second dataset such that the second dataset is associated with the statistical shape of the first dataset to at least a threshold similarity level.

3. The system of claim 1, wherein the one or more processors, to process the first dataset to identify the one or more characteristics of the first dataset, are configured to:
identify a volume of the first dataset; and
wherein the one or more processors, to generate the second dataset, are configured to:
generate the second dataset such that the second dataset is associated with the volume of the first dataset to at least a threshold similarity level.

4. The system of claim 1, wherein the one or more processors, to generate the second dataset, are configured to:
generate artificial text for the second dataset using a text generation type of artificial intelligence model.

5. The system of claim 1, wherein the one or more processors, to generate the second dataset, are configured to:
generate artificial text for the second dataset using a set of configured text snippets.

6. The system of claim 1, wherein the one or more processors are further configured to:
generate a data structure for storing the second dataset; and
update one or more resource addresses in the application from a first address associated with the first dataset to a second address associated with the data structure for storing the second dataset.

7. The system of claim 1, wherein the one or more processors are further configured to:
transmit an alert indicating a failure associated with generation of at least a portion of the second dataset;
receive input identifying information for the at least the portion of the second dataset; and
re-train the machine learning intelligence model using the input identifying the information for the at least portion of the second dataset.

8. The system of claim 1, wherein the one or more processors are further configured to:
detect a change to the first dataset;
re-process the first dataset to determine an updated one or more characteristics of the first dataset; and
alter the second dataset based on the updated one or more characteristics of the first dataset.

9. The system of claim 1, wherein the one or more criteria relate to at least one of:
confidential information,
personal identification information,
restricted access information, or
compliance-subjected information.

10. A non-transitory computer-readable medium storing a set of instructions, the set of instructions comprising:
one or more instructions that, when executed by one or more processors of a device, cause the device to:
receive a request to execute a set of tests on an application using a first test environment,
wherein the first test environment includes one or more data elements that satisfy one or more criteria for classification as having private information;
process, using a machine learning model, the first test environment to identify one or more characteristics of the first test environment;
generate, using the machine learning model, a second test environment based on the first test environment,
wherein the second test environment includes artificially generated test elements,
wherein the artificially generated test elements are associated with the one or more characteristics identified for the first test environment, and
wherein the artificially generated test elements do not satisfy the one or more criteria for classification as having private information;
execute the set of tests on the application using the second test environment; and
transmit an output identifying a result of executing the set of tests.

11. The non-transitory computer-readable medium of claim 10, wherein the artificially generated test elements include at least one of:
a data element,
another application,
an address,
a computing resource, or
a data structure.

12. The non-transitory computer-readable medium of claim 10, wherein the one or more instructions, when executed by the one or more processors for the device, cause the device to:
allocate a set of resources to the second test environment; and
wherein the one or more instructions, that cause the device to execute the set of tests, cause the device to:
execute the set of tests using the set of resources.

13. The non-transitory computer-readable medium of claim 10, wherein the one or more characteristics of the first test environment include a characteristic relating to:
a resource allocation of the first test environment,
a set of applications available in the first test environment, or
a set of data structures available in the first test environment.

14. A method for application testing, comprising:
receiving, by a testing system, a request for generation, based on a first dataset, of a second dataset, wherein the first dataset is associated with execution of a set of tests on an application,
wherein the first dataset includes one or more data elements that satisfy one or more criteria for classification as private information;
processing, by the testing system and using a machine learning model, the first dataset to identify one or more characteristics of the first dataset;
generating, by the testing system and using the machine learning model, the second dataset based on the first dataset,
wherein the second dataset includes artificially generated data elements,
wherein the artificially generated data elements are associated with the one or more characteristics identified for the first dataset, and
wherein the artificially generated data elements do not satisfy the one or more criteria for classification as private information; and
transmitting, by the testing system, an output identifying the second dataset.

15. The method of claim 14, wherein the output includes at least one of:
a content of the second dataset, or
an address for accessing the second data.

16. The method of claim 14, wherein processing the first dataset to identify the one or more characteristics of the first dataset comprises:
identifying a statistical shape of the first dataset; and
wherein generating the second dataset comprises:
generating the second dataset such that the second dataset is associated with the statistical shape of the first dataset to at least a threshold similarity level.

17. The method of claim 14, wherein processing the first dataset to identify the one or more characteristics of the first dataset comprises:
identifying a volume of the first dataset; and
wherein generating the second dataset comprises:
generating the second dataset such that the second dataset is associated with the volume of the first dataset to at least a threshold similarity level.

18. The method of claim 14, wherein generating the second dataset comprises:
generating artificial text for the second dataset using a text generation type of artificial intelligence model.

19. The method of claim 14, wherein generating the second dataset comprises:
generating artificial text for the second dataset using a set of configured text snippets.

20. The method of claim 14, further comprising:
generating a data structure for storing the second dataset; and
transmitting output identifying one or more resource addresses for the application to access the data structure storing the second dataset.
